(19) United States
(12) Patent Application Publication
(10) Pub. No.: US 2002/0074376 A1
(43) Pub. Date: Jun. 20, 2002

(54) Hair foil package dispenser

(76) Inventor: Eric Polesuk, Randolph, NJ (US)

Correspondence Address: Philip M. Weiss, Weiss & Weiss, Suite 305, 500 Old Country Road, Garden City, NY, 11530, US

(21) Appl. No.: 09/742,691

(22) Filed: Dec. 20, 2000

(51) Int. Cl. B26F 3/02

(52) U.S. Cl. 225/39; 225/56

(57) ABSTRACT

Self dispensing box that contains an integrated metal cutting edge that allows a roll of foil to be unrolled and quickly, efficiently, and precisely cut into sheets of varying length. A “self-dispenser” shall be defined as a packaging device that doubles as a dispenser; capable of dispensing from the products original package.

### FIELD OF THE INVENTION

Self dispensing box that contains an integrated cutting edge that allows a roll of foil to be unrolled and quickly, efficiently, and precisely cut into sheets of varying length. A “self-dispenser” shall be defined as a packaging device that doubles as a dispenser; capable of dispensing from the products original package.

### BACKGROUND OF THE INVENTION

Aluminum foil is used in the Beauty Industry for highlighting (tinting) hair. Foil is supplied to the industry in both sheet and/or roll formats. Ultimately foil rolls need to be converted into sheets such that they can be placed into the hair for such highlighting techniques. The conversion of roll foil typically occurs with some form of dispensing mechanism. Dispensers hold foil rolls in place while the user pulls the loose end of foil such that the foil roll begins to unwind. Most dispensers have some type of cutting mechanism, such as a serrated edge that is used to cut or tear the foil into sheets of varying length.

Foil rolls have been used in the Food service Industry for many years. With the exception of household and institutional foil rolls that range in width from 12″ to 24″, a common trend in the Beauty Industry is to work with a roll that ranges in width from 3.5″ to 6″. These rolls of narrower width are typically sold through the Professional Beauty distributors and offer much added convenience as stylists can then just pull off the length of foil desired, instead of having to first tear off the desired length from an institutional roll and then cutting it in half or thirds to achieve the desired width.

There are other self dispensing boxes used in the Beauty Industry to dispense rolls of foil with these narrow widths, but they do not contain an integrated cutting edge. In this case, the self dispensing box (made of boxboard or corrugated material) has one edge that is cut in a jagged-like pattern that acts as a cutting device. These types of jagged edges are typically not very sharp and therefore do not cut as effectively as an edge made of metal or plastic.

There are other types of dispensing units in the Beauty Industry to dispense aluminum foil, but they are not “self-dispensers”; they are separate systems all together. For example, a metallic or plastic rack designed to hold a roll(s) in place by supporting the roll through its core with some type of cylindrical device. These devices usually have sharp metal or plastic cutting edges in some type of configuration, but the systems themselves are not a self-dispenser as defined earlier.

U.S. Pat. No. 4,787,542 relates to a dispenser for dispensing sheet material, particularly metallic foil, positions each successively leading end region of the foil, after a preceding length of the foil has been served, to stand freely in a generally upright condition away from a serving means which is preferably provided without sharp serrated cutting teeth to protect a user from injury during use of the dispenser, and to provide the user with ready access to each upstanding leading end region of the foil.

U.S. Pat. No. 5,161,723 relates to a dispenser for paying out sections of a web of material from a dispenser roll. The dispenser has a housing which comprises a roll holder for the dispenser roll and an outlet opening. A stationary knife projects out of the outlet opening. An apportioning roller is supported in the housing in the path of the web of material from the dispenser roll to the outlet opening, it is adapted for stepwise rotation and to be arrested in a certain angular position by a control lever so as to define a section length of the web of material. The knife normally is covered by a cover strip adapted to be moved away from the knife by pulling at the web of material. The cover strip is connected to the control lever so that the latter releases the apportioning roller whenever the web of material has been severed.

U.S. Pat. No. 5,947,360 relates to a cutting blade for cutting sheet materials such as plastic film or metal foil. The cutting blade incorporates a row of cutting teeth projecting from a flat surface between the surface's folded edges. The depth of cut of the cutting blade is limited by the height that the cutting teeth project from the flat surface. By spacing the cutting teeth sufficiently closely together, the cutting teeth provide a bearing surface sufficient to support human skin so the cutting blade cuts plastic film and metal foil, but does not easily puncture human skin.

U.S. Pat. No. 5,984,158 relates to a cutting assembly for aluminum foil dispensers. The cutting assembly comprises a member corresponding to the length of the dispenser carton. The member has a U-shaped cross-section adapted to slip over the free edge of the front panel of the dispenser carton having a base web with one leg on the inside of the carton and a second leg exposed on the outside of the carton. The inside leg has an extension which is bent back over the leg and extends the full height of the inside leg to project above the base web of the U-shaped member. The upward extension is serrated with a continuous row of teeth projecting above the base.

U.S. Pat. No. 6,105,481 relates to a foil dispenser having a housing which consists of a housing body with a roll chamber and a holder guide and a cover plate, a holder guide cover and a roll chamber cover. The roll chamber has a dispensing slot and the holder guide has a cutting slot. A cutting blade protects through the cutting slot and is fitted on a blade holder guided in the holder guide.

### SUMMARY OF THE INVENTION

The present invention relates to a hair foil package dispenser comprising; a container, a roll of hair foil, an opening in the container and an integrated cutting blade. The present invention relates to a self dispensing box container that contains an integrated cutting edge that allows a roll of foil to be unrolled and quickly, efficiently and precisely cut into sheets of varying length. It is an object of the present invention to provide both a packaging device and a dispenser, wherein the product contained in the package can be dispensed from the original package. It is an object of the present invention to package and dispense highlighting foil in the beauty industry. It is an object of the present invention to provide an integrated cutting device that can be made of a metal or plastic edge. It is an object of the present invention to provide a self dispenser constructed of any material that ranges in width and holds rolls of foil that have a width between 3.5″ and 6.0″.

### BRIEF DESCRIPTION OF THE DRAWING

FIG. 1 illustrates a front view of the package dispenser of the present invention.

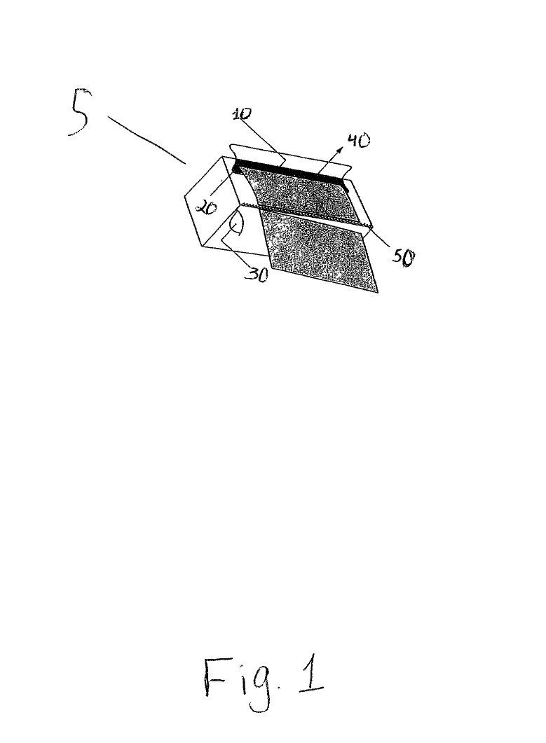

### DETAILED DESCRIPTION OF THE INVENTION

Package dispenser 5 contains a roll of foil 10. The roll of foil 10 can be any type of foil that is used in the beauty industry. The foil can be any thickness color or length that is desired. The roll of foil 10 is approximately 3½ to 6 inches in width. A slot or opening 20 is provided in the dispenser so that the foil 40 can be pulled through and eventually cut into desired pieces. Insert 30 is provided for placing the lid (not shown in the figure) of the package dispenser 5. The foil 40 is pulled by a user through the package dispenser 5 until the desired length of foil 40 is unrolled. The foil 40 is then cut with the integrated cutting blade 50. The integrated cutting blade 50 can be made of metal, plastic or another material which is used by those skilled in the art.

1. A hair foil package dispenser comprising;
a container;
a roll of hair foil;
an opening in said container;
an integrated cutting blade.

2. The package dispenser of claim 1 wherein said roll of hair foil has a width between approximately 3.5″ and 6.0″.

3. The package dispenser of claim 1 wherein said integrated cutting blade is made of metal or plastic.

4. The package dispenser of claim 1 wherein said container has a slot for placing a lid of said container.
